(19) United States
(12) Patent Application Publication
(10) Pub. No.: US 2004/0258271 A1
(43) Pub. Date: Dec. 23, 2004

(54) Method and system for providing eating/drinking services

(76) Inventor: Hiroshi Yano, Tsu-shi (JP)

Correspondence Address: RATNERPRESTIA, P O BOX 980, VALLEY FORGE, PA, 19482-0980, US

(21) Appl. No.: 10/493,882

(22) PCT Filed: Sep. 4, 2003
(86) PCT No.: PCT/JP03/11295

(30) Foreign Application Priority Data
Feb. 7, 2002 (JP) 2002-30330
Aug. 13, 2002 (JP) 200223521
Dec. 24, 2002 (JP) 2002-372687

(51) Int. Cl. H04R 1/00; H04R 9/06; H04R 11/02

(52) U.S. Cl. 381/405; 381/407; 381/409

(57) ABSTRACT

In a loudspeaker, even if an interval between a diaphragm and a yoke is small, a lead wire, an end of the coil wire of a voice coil, moves upward and downward in and/or over a cutout portion formed in the yoke, and does not collide with the yoke. The loudspeaker does not have disadvantages, such as noises and disconnection of the end of the coil wire, and can be thin.

### TECHNICAL FIELD

The present invention relates to a loudspeaker used in a portable communication device, such as a portable telephone.

### BACKGROUND ART

A loudspeaker including a yoke, magnet 3 and a magnetic circuit integrated unitarily into a frame is disclosed in Japanese Patent Laid-Open Publication No.4-362900.

FIG. 4 is a sectional view of a conventional loudspeaker. Cylindrical yoke 101 having a bottom is made of magnetic material, such as iron. Frame 102 made of resin is fixed at an outer periphery of yoke 101 by being inserted with pressure or molding. Magnet 103 is spaced from inner surface 101a of a side wall of yoke 101 by a predetermined interval and is bonded to the bottom of yoke 101. Plate 104 is bonded on an upper surface of magnet 103 and provides magnetic gap 104a between the plate and inner surface 101a of yoke 101. Diaphragm 105 is formed by molding a resin sheet. Voice coil 106 is positioned in magnetic gap 104a and has an end bonded on a lower surface of diaphragm 105.

Voice coil 106 is formed by winding a coil wire having a heat welding layer on its surface and coated for insulating and heating the wound wire. Coil terminals 106a, both end portions of voice coil 106, are led from between diaphragm 105 and yoke 101, and connected by soldering to respective ends of external terminals 107 integrated with frame 102.

In the structure mentioned above, a sound signal is supplied from an external sound source through external terminals 107 to voice coil 106, and the voice coil 106 and diaphragm 105 vibrate to generate a sound.

The conventional loudspeaker is to be thin and make a large output for use in a portable communication device, such as a portable telephone, and coil terminals 106a led from between diaphragm 105 and yoke 101 may contact diaphragm 105 or yoke 101 according to a vibration of the loudspeaker driven, thereby producing a noise. The conventional loudspeaker accordingly requires a certain interval between diaphragm 105 and yoke 101, thus being prevented from having a reduced size.

### SUMMARY OF THE INVENTION

A loudspeaker includes a yoke, a magnet, a plate, a frame, a diaphragm, a voice coil, and an external terminal. The yoke has a tube shape having a bottom and a side wall having a first cutout portion formed therein. The magnet is spaced from the side wall of the yoke by a predetermined interval and provided on the bottom of the yoke. The plate is provided on the magnet and provides a magnetic gap between the plate and an inner surface of the side wall. The frame provided at an outer periphery of the yoke. The diaphragm has an edge thereof coupled to the frame. The voice coil is formed by winding a coil wire in the magnetic gap, and has an edge thereof coupled to the diaphragm. The external terminal is provided at the frame and connected to an end portion of the coil wire led from the voice coil. The first cutout portion is provided at a position corresponding to the end portion of the coil wire.

The loudspeaker can be thin since an interval between the diaphragm and the yoke can be short.

### BRIEF DESCRIPTION OF THE DRAWINGS

FIG. 1 is a sectional view of a loudspeaker in accordance with an exemplary embodiment of the present invention.

FIG. 2 is a top view of a voice coil and a yoke of the loudspeaker in accordance with the embodiment.

FIG. 3 is a top view of the voice coil and another yoke of a loudspeaker in accordance with the embodiment.

FIG. 4 is a sectional view of a conventional loudspeaker.

### DETAILED DESCRIPTION OF PREFERRED EMBODIMENT

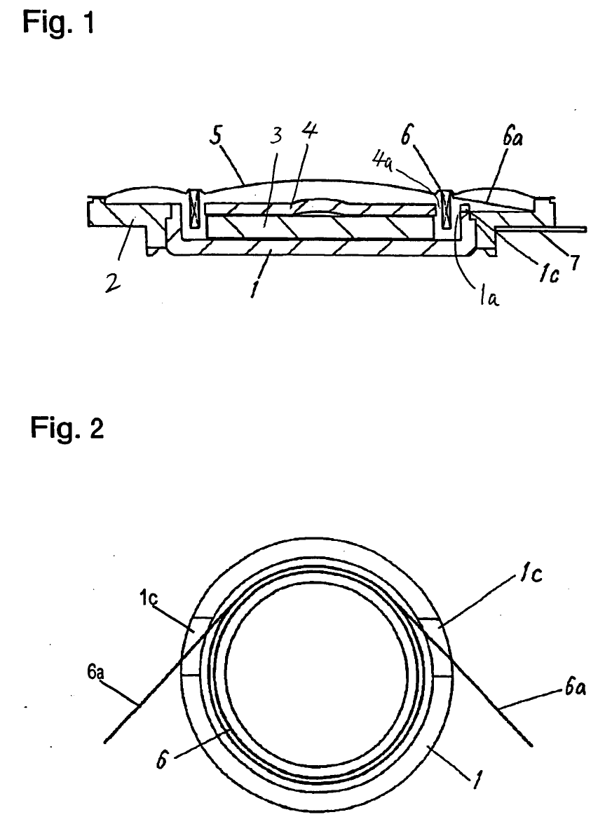

FIG. 1 is a sectional view of a loudspeaker in accordance with an exemplary embodiment of the present invention. FIG. 2 is a top view of a voice coil and a yoke, essential parts of the loudspeaker.

As shown in FIG. 1, cylindrical yoke 1 having a bottom is made of magnetic material, such as iron. Frame 2 made of resin is fixed at an outer periphery of yoke 1 by being inserted with pressure process or molding. Magnet 3 is spaced from inner surface 1a of a side wall of yoke 1 by a predetermined interval and is bonded on the bottom of yoke 1. Plate 4 is bonded on an upper surface of magnet 3 and forms magnetic gap 4a between the plate and inner surface 1a of yoke 1. Diaphragm 5 is formed by molding a resin sheet. Voice coil 6 is positioned in magnetic gap 4a and has an end bonded on a lower surface of diaphragm 5.

Voice coil 6 has an edge bonded on the lower surface of diaphragm 5, and has the other edge positioned in magnetic gap 4a. Voice coil 6 is formed by winding a coil wire having a heat welding layer on its surface and coated for insulating and heating the wound wire.

Lead wires 6a, both ends of the coil wire of voice coil 6, are led from the wound coil wire in a direction tangential to the wound coil wire through between diaphragm 5 and yoke 1, and electrically coupled with external terminals 7 at frame 2 by soldering.

According to the embodiment, a cylindrical wall of yoke 1 has cutout portions 1c formed under portions around lead wires 6a, the ends of the coil wire of voice coil 6, led from the wound coil wire in a direction tangential to the wound coil wire. In other words, cutout portions 1c are formed at positions corresponding to lead wires 6a, the ends of the coil wire.

Lead wires 6a, the ends of the coil wire, move in and over cutout portions 1c when lead wires 6a vibrates upward and down ward during driving of the loudspeaker. Therefore, even if an interval between diaphragm 5 and yoke 1 is short, cutout portions 1c maintains an interval between yoke 1 and lead wire 6a, an end of the coil wire, thus allowing the loudspeaker to be thin.

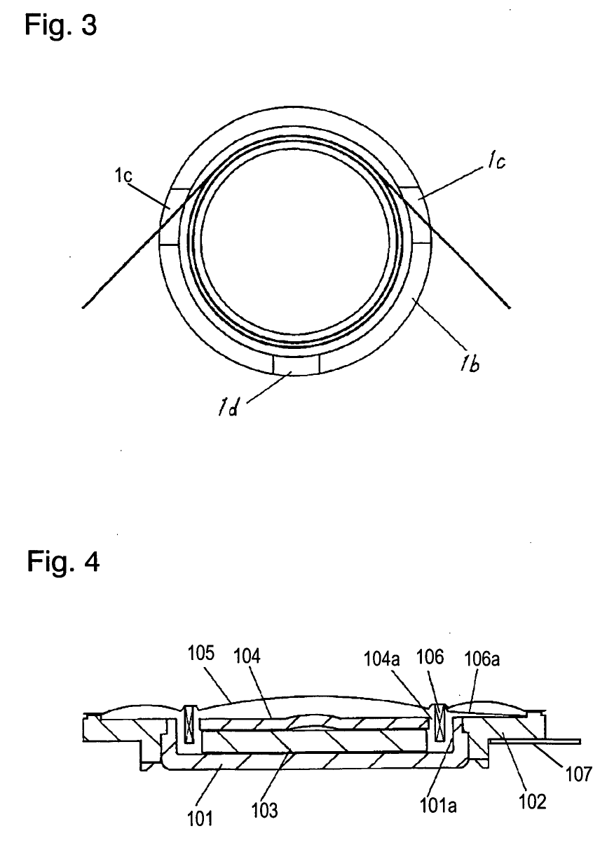

FIG. 3 is a top view of voice coil 6 and another yoke 1b of a loudspeaker in accordance with the embodiment. Yoke 1b further has cutout portion 1d formed therein.

Cutout portions 1c reduce a magnetic flux passing through voice coil 6 and may unbalance the magnetic flux. In case that cutout portions 1c is large and that an unbalanced portion of the magnetic flux is large, diaphragm 5 may roll according to its vibration and collide with yoke 1, thereby generating a noise. In the worst case, a problem that diaphragm 5 is broken may occur.

Cutout portion 1d reduces the magnetic flux partially as well as cutout portions 1c. Portion d cancels the unbalance of the magnetic flux in yoke 1b, hence eliminating the problem.

In the loudspeaker according to the embodiment, yokes 1 and 1b have cylindrical shapes, and however, may have other shapes, such as quadrilateral shapes.

In addition, lead wires 6a of voice coil 6 are placed over cutout portions 1c in FIG. 2, respectively. One of lead wires 6a may be placed over cutout portion 1c, and the other lead wire 6a may be led via another path.

### INDUSTRIAL APPLICABILITY

A loudspeaker according to the present invention has a cutout portion formed in a position of a yoke corresponding to a lead wire, an end of a coil wire, led from a voice coil, hence having a thin shape.

### REFERENCE NUMERALS

1 Yoke

1b Yoke

1c Cutout Portion

1d Cutout Portion

2 Frame

3 Magnet

4 Plate

4a Magnetic Gap

5 Diaphragm

6 Voice Coil

6a Lead Wire

7 External Terminal

1. A loudspeaker comprising:
a yoke having a tube shape having a bottom and a side wall, the side wall having a first cutout portion formed therein;
a magnet spaced from the side wall of the yoke by a predetermined interval and provided on the bottom of the yoke;
a plate provided on the magnet, the plate providing a magnetic gap between the plate and an inner surface of the side wall;
a frame provided at an outer periphery of the yoke;
a diaphragm having an edge thereof coupled to the frame;
a voice coil formed by winding a coil wire in the magnetic gap, the voice coil having an edge thereof coupled to the diaphragm; and
an external terminal provided at the frame and connected to an end portion of the coil wire led from the voice coil,
wherein the first cutout portion is provided at a position corresponding to the end portion of the coil wire.

2. The loudspeaker of claim 1, wherein the end portion of the coil wire is led in a direction tangential to the voice coil.

3. The loudspeaker of claim 1, wherein the side wall of the yoke has a second cutout portion formed therein.

4. The loudspeaker of claim 3, wherein the second cutout portion is operable to cancel unbalance of a magnetic flux between the yoke and the plate, the unbalance being caused by the first cutout portion.
